(19) United States
(12) Patent Application Publication
(10) Pub. No.: US 2007/0034770 A1
(43) Pub. Date: Feb. 15, 2007

(54) Electronic device and regulator thereof

(75) Inventor: Wen-Ping Chiu, Taoyuan County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/489,152

(22) Filed: Jul. 18, 2006

(30) Foreign Application Priority Data
Aug. 10, 2005 (TW) TW94127102

(51) Int. Cl. F16M 13/00

(52) U.S. Cl. 248/616

(57) ABSTRACT

An electronic device comprises a host and at least one regulator. The regulator disposed on the host comprises a body having a passage, a sliding element movably disposed in the passage, a foot element connected to the sliding element moving between a first position and a second position with respect to the sliding element, and a resilient element disposed in the passage with one end abutting on the sliding element.

### BACKGROUND

The invention relates to an electronic device and a regulator thereof, and in particular to a regulator using a gas damping force to eliminate vibration and external force generated by a host.

For a conventional projector or player, multiple bolted legs are employed to support a host and adjust the height or projecting angle thereof. However, the bolted legs are rigid and cannot eliminate vibration and external force generated by the host, resulting in fatigue and wear after long term operation.

### SUMMARY

The invention provides a regulator using a gas damping force to eliminate vibration and external force generated.

An electronic device of the invention comprises a host and at least one regulator. The regulator disposed on the host comprises a body having a passage, a sliding element movably disposed in the passage, a foot element connected to the sliding element moving between a first position and a second position with respect to the sliding element, and a resilient element disposed in the passage with one end abutting on the sliding element.

### DESCRIPTION OF THE DRAWINGS

The invention can be more fully understood by reading the subsequent detailed description and examples with references made to the accompanying drawings, wherein:

FIG. 1 is a perspective view of an electronic device (E) of the invention, disposed on a predetermined surface (W) via two regulators (K).

FIG. 2 is a perspective view of a regulator (K) of the invention.

FIG. 3 is an exploded view of the regulator (K) of FIG. 2.

FIG. 4A is a sectional view of the regulator (K) along line (A-A) in FIG. 2.

FIG. 4B is a plane view of the regulator (K) of FIG. 4A.

FIG. 5 is a plane view of the pressed regulator (K) of FIG. 4A.

### DETAILED DESCRIPTION

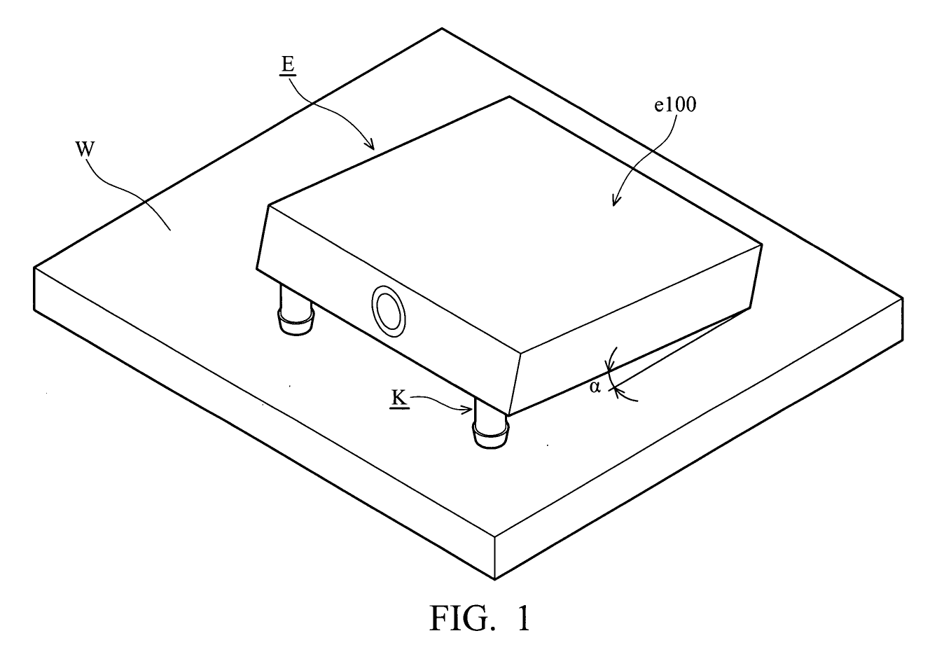

In FIG. 1, an electronic device E of the invention is disposed on a predetermined surface W via two regulators K. In the embodiment, the electronic device E is a projector having a host e100. The regulators K installed on the bottom of the host e100 for adjusting height and projecting angle of the host e100 and function as a damper to absorb energy generated from the host e100 to the predetermined surface W. Preferably, the regulators K can be connected to the host e100 by bonding or other connecting methods. However, it is to be understood that the invention is not limited to the number of the regulators K or the type of the electronic device E, where the electronic device E can also be a DVD player or any device requiring position adjustment and damping.

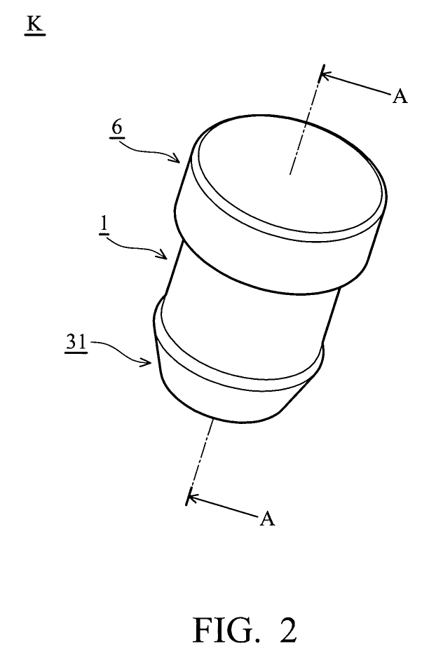

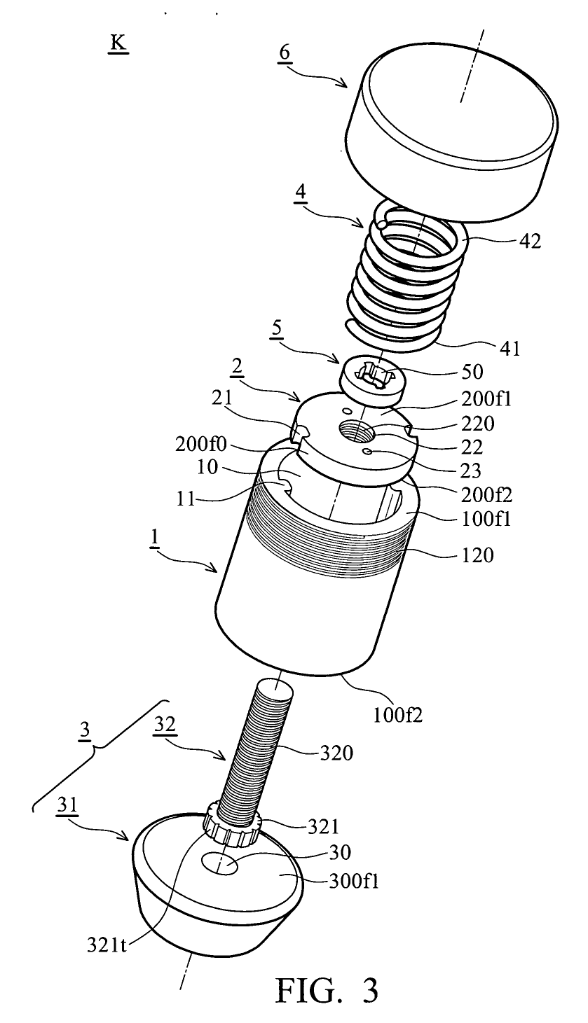

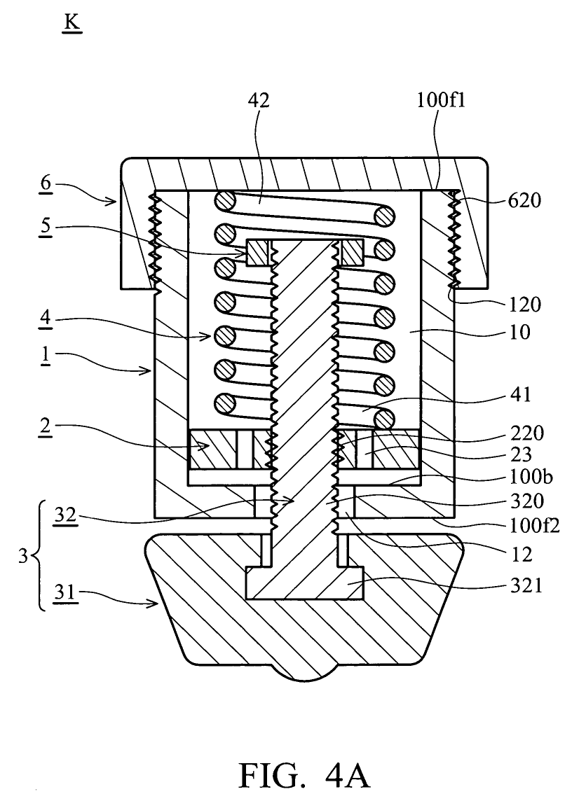

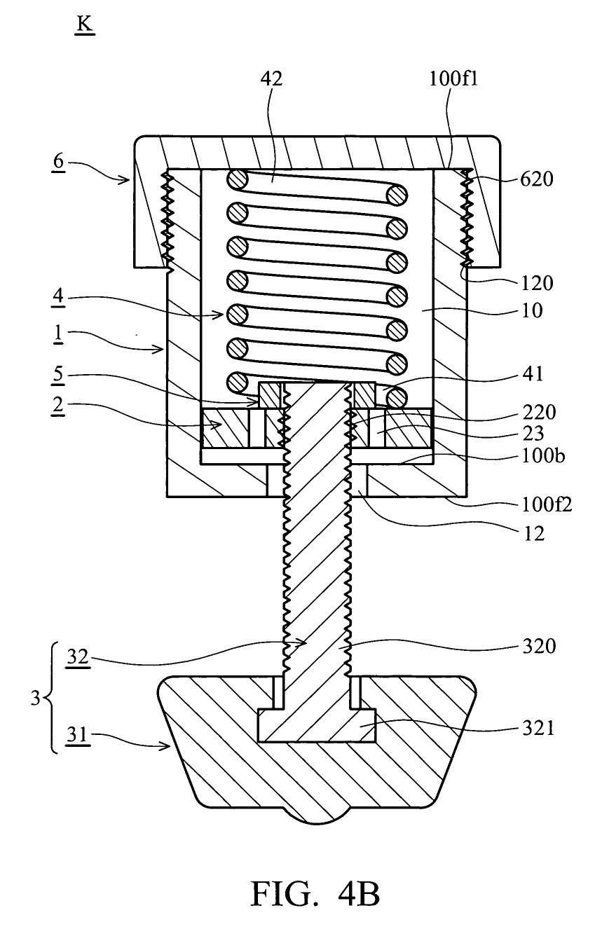

FIG. 2 is a perspective view of a regulator K and FIG. 3 is an exploded view of the regulator K. FIG. 4A is a sectional view of the regulator K along line A-A in FIG. 2.

In FIG. 3, the regulator K comprises a cylindrical body 1, a cylindrical sliding element 2, a foot element 3, a resilient element 4, a stopper 5 and a cover 6.

The body 1 comprises a passage 10, a pair of first guiding portions 11, a guiding hole 12 shown in FIG. 4 and a threaded region 120. The passage 10 is a recess formed on one end 100f1 of the body 1, and the guiding hole 12 is a through hole formed on the other end 100f2 of the body 1 and connected to the passage 10. The first guiding portions 11 are two protrusions formed on the inner wall of the passage 10. The threaded region 120 coming near the end 100f1 is formed on the outer surface of the body 1.

The sliding element 2 movably disposed in the passage 10 comprises a pair of second guiding portions 21, a positioning portion 22, two guiding holes 23, a periphery 200f0, an upper surface 200f1 and a lower surface 200f2. The second guiding portions 21 are two recesses formed on the periphery 200f0 and connecting the upper surface 200f1 and the lower surface 200f2. The second guiding portions 21 are configured to movably fit the first guiding portions 11 of the body 1, respectively. The positioning portion 22 is a through hole centrally formed and connecting the upper surface 200f1 and the lower surface 200f2. A first connecting portion 220 is a threaded region formed on the inner wall of the positioning portion 22. The guiding holes 23 are through holes functioning as air vents connecting the upper surface 200f1 and the lower surface 200f2.

It is to be understood that the invention is not limited to the disclosed number of first guiding portions 11 and second guiding portions 21 are two. In other embodiments, the body and the sliding element can be respectively configured with a single first guiding portion and a single second guiding portion, with the sliding element still movably disposed in the passage of the body by the fitted first and second guiding portions. The first guiding portion and the second guiding portion can be alternatively inversed, i.e., the first guiding portion formed on the body can be a recess, and the second guiding portion formed on the sliding element can be a protrusion.

The foot element 3 comprises a seat 31 having a positioning hole 30 and a post 32 having a second connecting portion 320 and a head 321. The seat 31 is a conical element of resilient mater such as rubber suitable for placement on different surfaces. The head 321 with a plurality of ribs 321t is plugged into the positioning hole 30 formed on a surface 300f1 of the seat 31, so that the seat 31 and the post 32 are securely combined. The second connecting portion 320 of the post 32 is movably connected to the first connecting portion 220 of the sliding element 2. In the embodiment, the second connecting portion 320 is a threaded region.

The resilient element 4 comprises two ends 41 and 42. The stopper 5 has a positioning hole 50 connected to the foot element 3. In the embodiment, the resilient element 4 is a compression spring, and the stopper 5 is a washer.

In FIG. 4A, the cover 6 has a U-shaped section and a threaded region 620 formed on an inner wall thereof, such that the cover 6 is detachably connected to the body 1 by connection of the threaded region 620 to the threaded region 120.

Assembly of the elements of the regulators K is depicted as the following steps incorporated with FIGS. 3 and 4A. First, the second guiding portions 21 of the sliding element 2 are fitted to the first guiding portions 11 of the body 1, such that the sliding element 2 moves along the first guiding portions 11, i.e., the sliding element 2 can reciprocally move in the passage 10 of the body 1. The post 32 of the foot element 3 is inserted into the passage 10 via the guiding hole 12 of the body 1 to connect the second connecting portion 320 thereof to the first connecting portion 220 of the sliding element 2. When the sliding element 2 located on the post 32 of the foot element 3 is relatively adjusted to a desired location, the positioning hole 50 of the stopper 5 is securely fixed at the end of the foot element 3. The resilient element 4 enclosing the stopper 5 and the post 32 is disposed in the passage 10 of the body 1, and the threaded region 620 of the cover 6 connects to the threaded region 120 of the body 1. The resilient element 4 clamped by the cover 6 and the sliding element 2 is in a compressed state, i.e., two ends 41, 42 of the resilient element 4 respectively press on the cover 6 and the sliding element 2. Thus, the foot element 3 can be moved between a first position (FIG. 4A) and a second position (FIG. 4B) with respect to the sliding element 2.

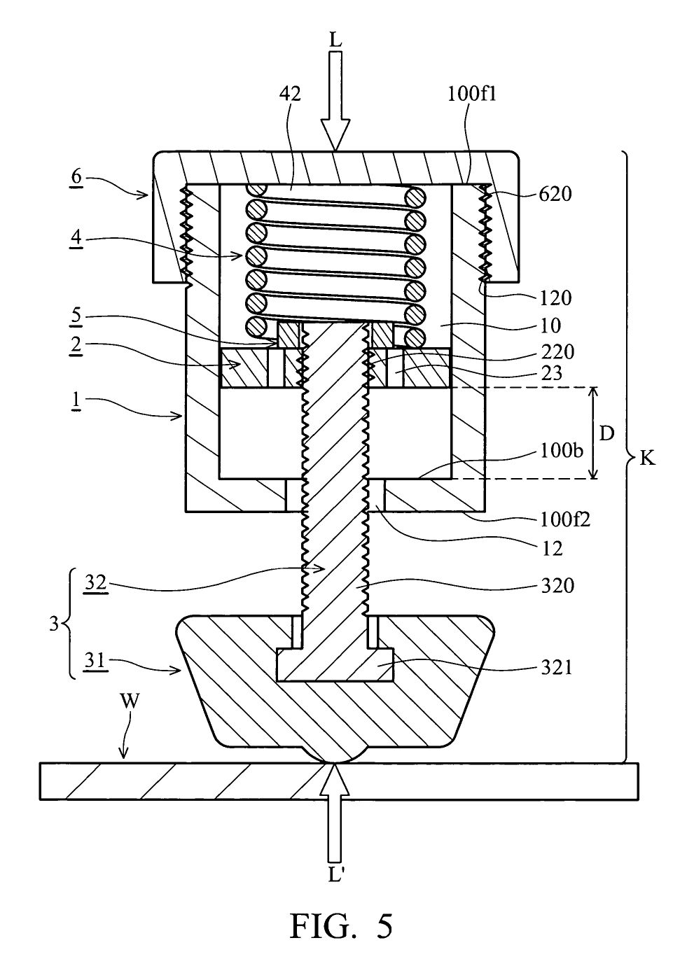

In FIG. 5, a weight L of the host e100 abuts the cover 6 of the regulator K located on the surface W, correspondingly generating a reacting force L′ onto the seat 31 of the foot element 3. The resilient element 4 compressed by the sliding element 2 and the cover 6 is shortened, i.e., the sliding element 2 is upwardly shifted by a displacement D with respect to the bottom surface 100b of the passage 10 of the body 1.

When the sliding element 2 is relatively moved along the passage 10 of the body 1, space receiving the resilient element 4 between the cover 6 and the sliding element 2 is relatively changed (decreased or increased). Air flow instantaneously generating from the space between the cover 6 and the sliding element 2 is expelled to the exterior via the guiding holes 23 and 12, or air flow from the exterior is exhausted into the space between the cover 6 and the sliding element 2 via the guiding holes 12 and 23, so that a damping effect is generated. The number, location and size of the guiding holes 23 can be changed according to different desired arrangements.

With a supporting force provided by the resilient element 4 and a gas damping force provided by the guiding holes 23, vibration and external force generated by the weight L disposed on the regulator K can be decreased or eliminated.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. A regulator, comprising:
a body having a passage;
a sliding element movably disposed in the passage;
a foot element connected to the sliding element, movable between a first position and a second position with respect to the sliding element;
and
a resilient element disposed in the passage with one end abutting on the sliding element.

2. The regulator as claimed in claim 1, wherein the body further comprises a first guiding portion to guide the sliding element along the passage.

3. The regulator as claimed in claim 1, wherein the body further comprises a first guiding portion, and the sliding element comprises a second guiding portion guided by the first guiding portion.

4. The regulator as claimed in claim 3, wherein the first guiding portion comprises a protrusion and the second guiding portion comprises a recess.

5. The regulator as claimed in claim 1, wherein the sliding element comprises a first connecting portion and the foot element comprises a second connecting portion movably connected to the first connecting portion.

6. The regulator as claimed in claim 5, wherein the first connecting portion and the second connecting portion each comprise a threaded region.

7. The regulator as claimed in claim 1, wherein the sliding element comprises at least one guiding hole connected to the passage of the body.

8. The regulator as claimed in claim 1 further comprising a stopper connected to the foot element.

9. The regulator as claimed in claim 8, wherein the stopper comprises a washer.

10. The regulator as claimed in claim 1 further comprising a cover detachably connected to the body, so that the sliding element, the foot element and the resilient element are disposed between the cover and the body.

11. An electronic device, comprising:
a host; and
at least one regulator disposed on the host, comprising:
a body having a passage;
a sliding element movably disposed in the passage;
a foot element connected to the sliding element, movable between a first position and a second position with respect to the sliding element; and
a resilient element disposed in the passage with one end abutting on the sliding element.

12. The electronic device as claimed in claim 11, wherein the body further comprises a first guiding portion to guide the sliding element along the passage.

13. The electronic device as claimed in claim 11, wherein the body further comprises a first guiding portion, and the sliding element comprises a second guiding portion guided by the first guiding portion.

14. The electronic device as claimed in claim 13, wherein the first guiding portion comprises a protrusion and the second guiding portion comprises a recess.

15. The electronic device as claimed in claim 11, wherein the sliding element comprises a first connecting portion and the foot element comprises a second connecting portion movably connected to the first connecting portion.

16. The electronic device as claimed in claim 15, wherein the first connecting portion and the second connecting portion each comprise a threaded region.

17. The electronic device as claimed in claim 11, wherein the sliding element comprises at least one guiding hole connected to the passage of the body.

18. The electronic device as claimed in claim 11 further comprising a stopper connected to the foot element.

19. The electronic device as claimed in claim 18, wherein the stopper comprises a washer.

20. The electronic device as claimed in claim 11 further comprising a cover detachably connected to the body, whereby the sliding element, the foot element and the resilient element are disposed between the cover and the body.
